(19) United States
(12) Patent Application Publication
(10) Pub. No.: US 2026/0148585 A1
(43) Pub. Date: May 28, 2026

(54) SYSTEMS AND METHODS FOR MONITORING A QUEUE

(71) Applicant: ServiceNow, Inc., Santa Clara, CA (US)

(72) Inventor: Ravindra Guntur, Hyderabad (IN)

(21) Appl. No.: 18/958,101

(22) Filed: Nov. 25, 2024

(51) Int. Cl. G06V 40/20

(52) U.S. Cl. CPC G06V 40/20

(57) ABSTRACT

A method includes receiving a first and second images of a queue at first and second times, respectively detecting a first human form at a first location in the first image, detecting a second human form at a second location in the second image, determining, based on respective characteristics of the first human form and the second human form, that the first human form corresponds to the second human form, determining a number of pixels between the first location and the second location, and determining a speed of the queue based on the number of pixels between the first location and the second location and an amount of time elapsed between the first time and the second time.

### TECHNICAL FIELD

The present disclosure relates generally to identifying and monitoring queues.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In various environments in which people form queues (e.g., stores, airports, performing arts venues, sports venues, restaurants, concession stands, transit stations, service centers, etc.), information about how long queues are and how quickly queues are moving can be useful in determining when to open or close registers or processing locations (e.g., ticket takers, checkpoints, etc.). Typically, queue monitoring is performed by one or more humans observing one or more queues in person or remotely via a camera. However, queue monitoring by humans tends to be subjective based on the judgment of the human, not standardized, subject to human error, and not scalable to a large number of queues. Accordingly, new techniques for autonomously monitoring queues that are objective, standardized, and scalable to a large number of queues are needed.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method includes receiving a first and second images of a queue at first and second times, respectively detecting a first human form at a first location in the first image, detecting a second human form at a second location in the second image, determining, based on respective characteristics of the first human form and the second human form, that the first human form corresponds to the second human form, determining a number of pixels between the first location and the second location, and determining a speed of the queue based on the number of pixels between the first location and the second location and an amount of time elapsed between the first time and the second time.

In another embodiment, a system includes processing circuitry and a memory, accessible by the processing circuitry, and storing instructions that, when executed by the processing circuitry, cause the processing circuitry to execute a client instance. The client instance is configured to perform operations including receiving a first and second images of a queue at first and second times, respectively detecting a first human form at a first location in the first image, detecting a second human form at a second location in the second image, determining, based on respective characteristics of the first human form and the second human form, that the first human form corresponds to the second human form, determining a number of pixels between the first location and the second location, and determining a speed of the queue based on the number of pixels between the first location and the second location and an amount of time elapsed between the first time and the second time.

In a further embodiment, a non-transitory, computer readable medium includes instructions that, when executed by processing circuitry, cause the processing circuitry to perform operations including receiving a first and second images of a queue at first and second times, respectively detecting a first human form at a first location in the first image, detecting a second human form at a second location in the second image, determining, based on respective characteristics of the first human form and the second human form, that the first human form corresponds to the second human form, determining a number of pixels between the first location and the second location, and determining a speed of the queue based on the number of pixels between the first location and the second location and an amount of time elapsed between the first time and the second time.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating a virtual server that supports and enables a client instance that identifies and monitors queues, in accordance with aspects of the present disclosure;

FIG. 5A illustrates an image of a queue that includes multiple human forms, in accordance with aspects of the present disclosure;

FIG. 5B illustrates the image of the queue of FIG. 5A in which a respective bounding box has been added for each of the human forms in the queue, in accordance with aspects of the present disclosure;

FIG. 5C illustrates the image of FIG. 5B in which the human forms, and in some embodiments, other objects present in the image have been removed, in accordance with aspects of the present disclosure;

FIG. 6 is a flow chart of a process for identifying the queue in the image of FIG. 5A, in accordance with aspects of the present disclosure;

FIG. 7 is a flow chart illustrating human form detection in the captured image of the queue, in accordance with aspects of the present disclosure;

FIG. 8 is a flow chart of a process for generating and comparing embeddings in monitoring the queue, in accordance with aspects of the present disclosure;

FIG. 9 is a flow chart of a process for identifying the human forms in different images of the queue using multiple embedding models, in accordance with aspects of the present disclosure; and

FIG. 10 is a flow chart of a process for monitoring the queue, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function(s) described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

In addition, as used herein, the terms “real time”,“real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic”, “automated”, “autonomous”, and so forth, are intended to describe operations that are performed are caused to be performed, for example, by a computing system (i.e., solely by the computing system, without human intervention). Indeed, although certain operations described herein may not be explicitly described as being performed automatically in substantially real time during operation of the computing system and/or equipment controlled by the computing system, it will be appreciated that these operations may, in fact, be performed automatically in substantially real time during operation of the computing system and/or equipment controlled by the computing system to improve the functionality of the computing system (e.g., by not requiring human intervention, thereby facilitating faster operational decision-making, as well as improving the accuracy of the operational decision-making by, for example, eliminating the potential for human error), as described in greater detail herein.

In various environments in which people form queues (e.g., stores, airports, performing arts venues, sports venues, restaurants, concession stands, transit stations, service centers, etc.), information about how long queues are and how quickly queues are moving can be useful in determining when to open or close registers or processing locations (e.g., ticket takers, checkpoints, etc.). Typically, queue monitoring is performed by one or more humans observing one or more queues in person or remotely via a camera. However, queue monitoring by humans tends to be subjective based on the judgment of the human, not standardized, subject to human error, and not scalable to a large number of queues. Accordingly, new techniques for autonomously monitoring queues that are objective, standardized, and scalable to a large number of queues are needed.

Various embodiments disclosed herein are directed to autonomously identifying and monitoring queues of people. Frames (e.g., still images, or frames from a video) of one or more queues may be captured by one or more cameras. Computer vision techniques paired with a machine learning model may be used to detect human forms in the frames. Each human form in the frame may then be converted into bounding boxes such that each individual in the frame is anonymized (by removing any identifying characteristics). The queue may be identified based on an analysis of the bounding boxes in the frame. In particular, the characteristics of the bounding boxes in the frame (e.g., the size, shape, arrangement, number of bounding boxes) may be used to identify that a queue has formed. In some embodiments, each bounding box in the frame may be converted into one or more vectors based on coordinates of the respective corners of the bounding box. The resulting vectors may be run through a clustering algorithm to identify queues. Here, large clusters of vectors (e.g., greater than some threshold value) may be identified as queues and small clusters (e.g., corresponding to groups of one or two people that appear in frames) may be ignored. In another embodiment, a line passing through respective coordinates of the bounding boxes may be provided to a curve fitting algorithm. In these embodiments, lines having certain characteristics may be identified as queues. In further embodiments, a neural network trained on a training data set of human-annotated frames may be configured to receive the frames or characteristics of the bounding boxes and identify queues.

Once a queue has been identified, the queue can be monitored by analyzing movement of people in the queue between a target frame and a reference frame. For example, one or more human forms may be detected in the reference frame and respective embeddings created for each detected human form. In some embodiments, multiple algorithms or models may be used to generate respective embeddings for the detected human form. Hashes identifying the human forms may be generated based on the embeddings and stored in a database. Similarly, one or more human forms may be detected in the target frame and respective embeddings created for each human form. As with the reference frame, multiple algorithms or models may be used to generate respective embeddings for the human forms. The database is searched for hashes generated for the reference frame and the target frame that match, indicating that a corresponding human form appears in both the reference frame and the target frame. If there are no matches between the reference frame and the target frame, the process is repeated with the target frame as the reference frame and a subsequent frame (e.g., a new frame) as the target frame. The location of the detected human form in the reference frame and the target frame may be compared to determine a number of pixels the human form moved between the reference frame and the target frame. Further, the timestamps of the reference frame and the target frame may be compared to determine an elapsed time between the reference frame and the target frame. Based on the number of pixels moved and the elapsed time for one or more human forms in the queue, the speed of the queue may be determined.

The length of the monitored queues and the speed at which the monitored queues move may be used to make determinations about when to open and close registers and/or processing stations, assess performance of cashiers or other operators, and evaluate processes. Accordingly, use of the disclosed techniques may provide more objective, standardized, and scalable monitoring of queues, as well as reduced time in the queue for customers and improved customer experiences.

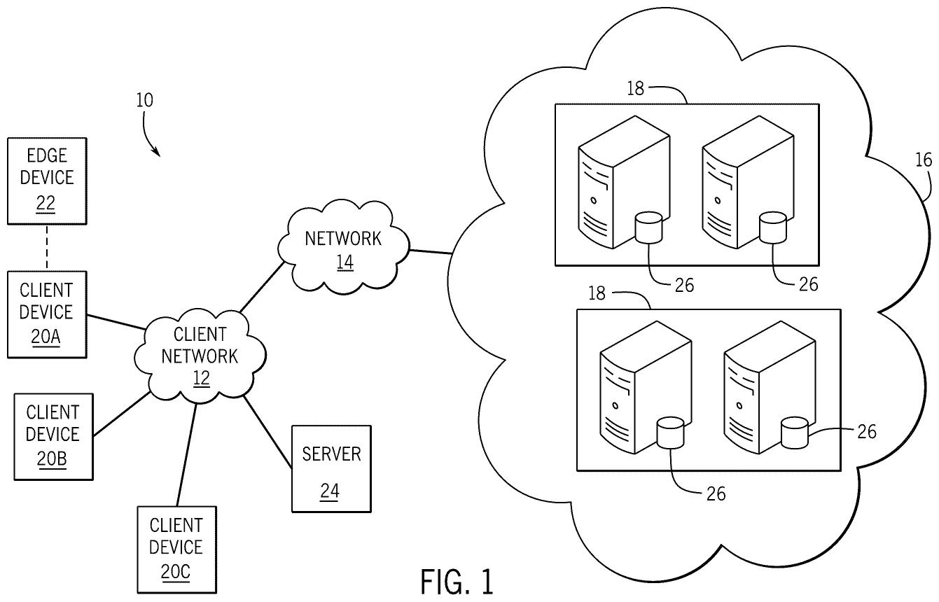

With the preceding in mind, the following figures relate to various types of generalized system architectures or configurations that may be employed to provide services to an organization for which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20A, 20B, 20C may be computing systems and/or other types of computing devices that access cloud computing services, for example, via a web browser application or via an edge device 22 that may act as a gateway between the client devices 20A, 20B, 20C and the platform 16. FIG. 1 also illustrates that the client network 12 includes an administration or managerial application, device, agent, or server, such as a server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20A, 20B, 20C and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20A, 20B, 20C via the client network 12 and network 14. The network hosting the platform 16 provides additional computing resources to the client devices 20A, 20B, 20C and/or the client network 12. For example, by utilizing the network hosting the platform 16, users of the client devices 20A, 20B, 20C are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

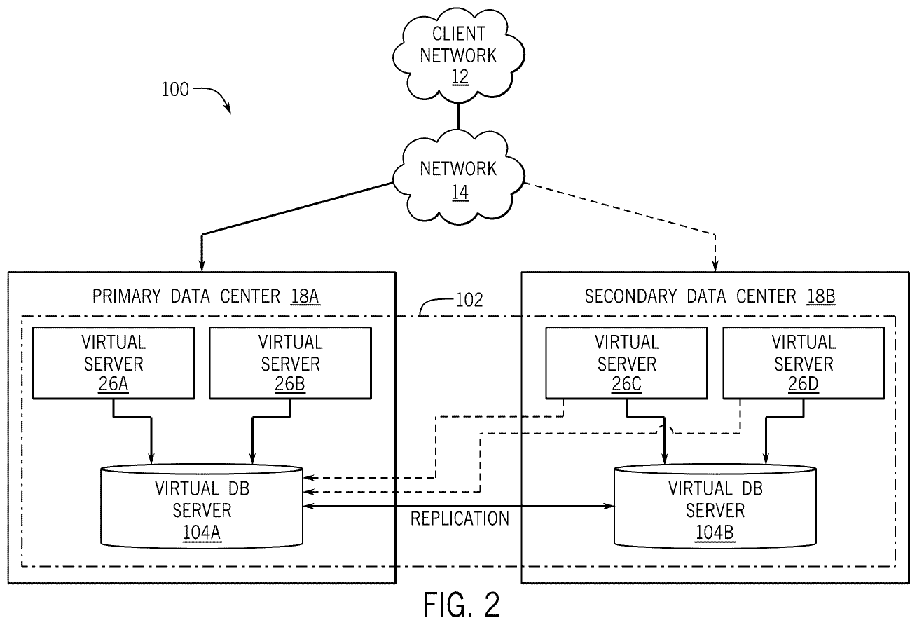

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

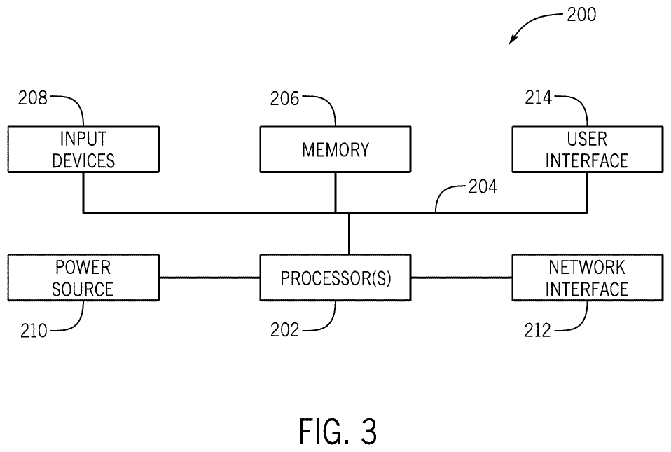

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202 (e.g., processing circuitry), one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

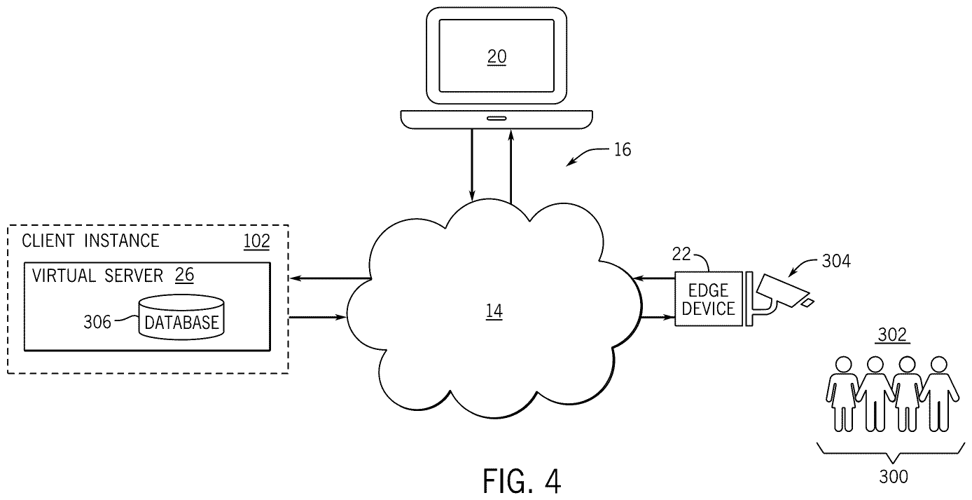

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The client instance 102 is supported by virtual servers 26 similar to those explained with respect to FIG. 2, and is illustrated here to show support for the disclosed functionality described herein within the client instance 102.

As shown, multiple people (e.g., customers) may form a queue 300 in an environment 302 (e.g., a store, an airport, a performing arts venue, a night club, a sports venue, a bar or restaurant, a concession stand, a transit station, a service center, a government office, etc.). Though FIG. 4 shows a queue of people, it should be understood that the presently disclosed techniques may be used to detect and monitor queues of other objects, such as cars, trucks, motorcycles/scooters, bicycles, train cars, aircraft, and other vehicles, boxes, animals, products of manufacturing/assembly processes on an assembly line, conveyor belt, or other movement system, and so forth. The cloud-based platform 16 is connected to a client device 20, via the network 14 to provide a user interface to network applications executing within the client instance 102 (e.g., via a web browser or a native application running on the client device 20) to monitor the queue 300. Specifically, a camera 304 or other imaging device may be used to capture still images or video of the queue 300. The camera 304 may be communicatively coupled to an edge device 22, which may receive images from the camera 304 and transmit images (e.g., raw images or processed images), or data extracted from the images, to the client instance 102, via the network 14 for further processing and to generate queue monitoring results (e.g., the length of the queue, the number of people in the queue, how quickly the queue is moving, whether to open of close processing stations, etc.). The client device 20 may access the client instance 102, from a remote or onsite location, to review queue monitoring results and take certain actions, such as opening or closing a processing station, and so forth. As shown, the virtual server 26 hosted by the client instance 102 may store or otherwise have access to a database, which may store various data associated with processing images captured by the camera 304 and/or monitoring the queue 300.

Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with the client instance 102 using an application and/or a web browser.

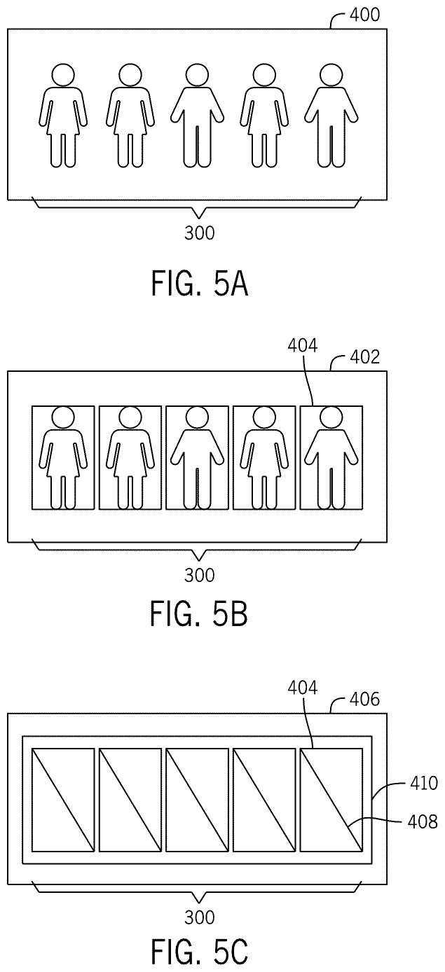

FIGS. 5A-5C illustrate an image processing sequence performed on images captured by the camera 304 shown in FIG. 4. It should be understood that the processing sequence shown in FIGS. 5A-5C may be performed by the edge device 22 of FIG. 4, the client device 102 of FIG. 4, or by a combination of the edge device 22 and the client instance 102 of FIG. 4. FIG. 5A illustrates a raw image 400 of the queue 300 that includes multiple human forms. As previously described, the present techniques may be used to detect and monitor queues of objects other than humans. Accordingly, though the term “human form” is used throughout, it should be understood that “human form” may be intended to be a representation of any object that may form a queue.

FIG. 5B illustrates an image 402 of the queue 300 in which a respective bounding box 404 has been added for each of the human forms in the queue 300. For example, computer vision may be used to identify human forms in the queue 300 and draw bounding boxes 404 around each of the human forms, such that the human forms fit inside the bounding boxes 404. In some embodiments, the human forms may contact the bounding boxes 404 on one, multiple, or all sides. Though the bounding boxes 404 shown in FIG. 5B are rectangular, in some embodiments, the bounding boxes 404 may be other shapes (e.g., triangles, squares, parallelograms, trapezoids, hexagons, heptagons, octagons, polygons, or other enclosed shapes). Further, though the bounding boxes 404 in FIG. 5B are single layer bounding boxes, the bounding box may include multiple layers (e.g., multiple nested and/or concentric bounding boxes), which may have different characteristics (e.g., border color, border weight/thickness, border line style, such as dashed), and so forth. For example, a human form may be represented by a series of concentric or nested bounding boxes of different colors, along with a diagonal line passing through opposite corners of the boxes. In such embodiments, the layers of a bounding box may communicate one or more characteristics of the human form corresponding to the bounding box, such as one or more colors that appear in the human form, one or more shapes that appear in the human form, and so forth.

FIG. 5C illustrates a processed image 406 in which the human forms, and in some embodiments, other objects in raw image 400 have been removed, or the pixels in the image set to a color to obscure the objects. In some embodiments, all of the elements of the original raw image may be removed from the processed image 406, such that the processed image 406 includes only annotations added to the raw image, such as the bounding boxes 404, lines/vectors 408 within the bounding boxes, an area of interest drawn around the bounding boxes 404, and so forth. As shown, in some embodiments, the bounding boxes 404 may include lines 408 representing vectors extending from one corner of the respective bounding box 404 to another corner of the bounding box 404. For example, the number of corners of the bounding box may correspond to the number of dimensions of the vector such that the coordinates of each corner of the bounding box are the vector values for a dimension (e.g., a vector for a four-corner bounding box may be a four-dimensional vector with the coordinates of each of the four corners serving as the value for a respective dimension). The vector may represent various characteristics of the bounding box 404, such as the position of the bounding box 404, the size of the bounding box 404, characteristics of the human forms about which the bounding box 404 was created (e.g., colors in the human form, shapes in the human form, etc.). Further, the processed image 406 includes an area of interest 410 for the queue that includes all of the bounding boxes 404 corresponding to the human forms in the queue.

Some enterprises or organizations using the disclosed techniques may have policies against transmitting images of people (e.g., customers, employees, etc.) to the cloud and/or storing images of people in the cloud. Accordingly, in some embodiments, the processing sequence shown in FIGS. 5A-5C may be performed on premises (“on-prem”), such as on the edge device 22 shown in FIG. 4, on a local server 24, on a client device 20, etc. However, in other embodiments, the processing sequence shown in FIGS. 5A-5C may be performed by a remote server, by the client instance 102, or in a distributed fashion across multiple of the client device 20, the edge device 22, the local server 24, the client instance 102, and/or a remote server.

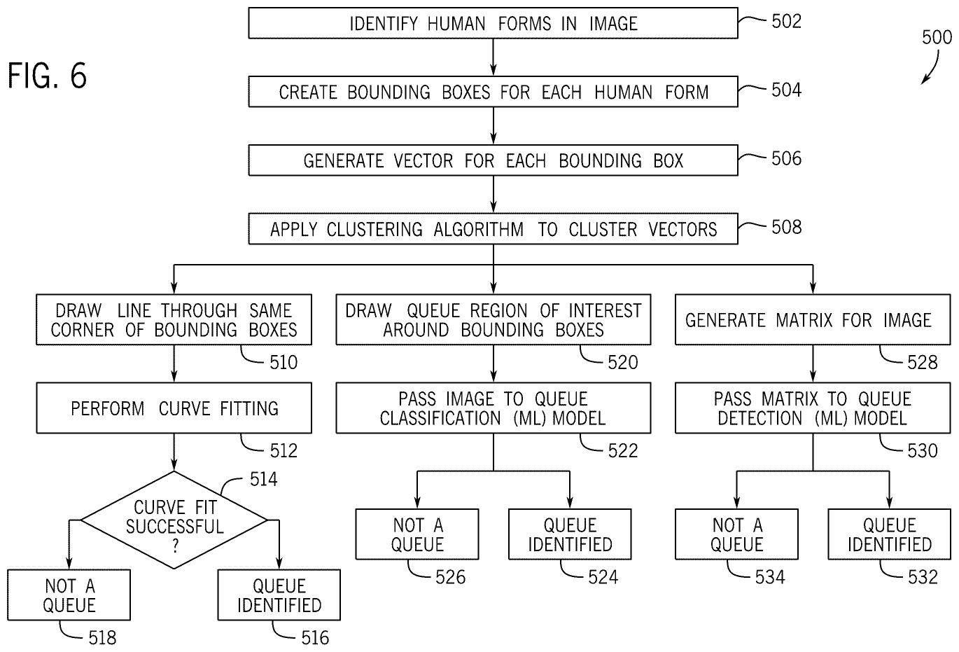

FIG. 6 is a flow chart of a process 500 for identifying queues in captured images. At block 502, the process 500 identifies human forms in a captured image. The human forms may be identified using computer vision, one or more object/pattern recognition algorithms or using one or more other techniques.

At 504, the process 500 generates one or more bounding boxes around each human form identified at block 502. As previously described, in some embodiments, the bounding box may include a single-layer four-sided box around the exterior of each human form. In other embodiments, the bounding boxes may have more complex shapes (e.g., triangles, squares, parallelograms, trapezoids, hexagons, heptagons, octagons, polygons, or other enclosed shapes), and/or the bounding boxes may have multiple layers (e.g., multiple nested bounding boxes) that connote various characteristics of the enclosed human form (e.g., shape, size, color, etc.) by utilizing various bounding box characteristics (e.g., border color, border weight/thickness, border line style, such as dashed, etc.). In further embodiments, each human form may be represented by a series of nested or concentric bounding boxes of different colors.

At 506, the process 500 generates a vector for each bounding box. In some embodiments, the vector may have the same number of dimensions that the bounding box has corners, with the coordinates of each corner being the value for a given dimension. In such an embodiment, for example, the process 500 may generate a four-dimensional bounding box for a rectangular bounding box such that the values for the four dimensions of the vector correspond to the coordinates of the four corners of the bounding box. In other embodiments, the vector may be a two-dimensional vector that extends diagonally across the bounding box from a first corner to a second corner (e.g., as shown in FIG. 5C). In other embodiments, the vector for each bounding box may be a multi-dimensional vector that encodes various information about the bounding box or human forms within the bounding box, such as shapes, colors, sizes, characteristics, etc.

At 508, the process 500 applies a clustering algorithm to cluster the vectors associated with the bounding boxes. For example, the bounding boxes in each cluster may be organized on a matrix such that all of the rows and columns of the matrix are set to zero and the pixels that overlap with the bounding boxes are set to one. After the clustering algorithm has been applied, the process 500 may proceed according to one or more of three embodiments, as shown in FIG. 6.

For example, at 510, the process 500 may draw a line through the same corner (e.g., top left-hand corner) of the bounding boxes in the cluster. Typically, rather than being straight line, the line through the corners of the bounding boxes is likely a spline or a concatenation of lines. At 512, the process 500 performs curve fitting. For example, the process 500 may run a coefficient of determination test (“R² test”) on the points on the line through the bounding boxes to determine a value for linearity of the line. If the linearity is above a threshold value, curve fitting is successful (block 514) and the queue is determined to be a straight queue (block 516). If the linearity is low, the process 500 attempts to find a curve or a series of curves that fits the line. If the process 500 is successful in fitting a curve to the line, the process 500 proceeds to 516 and confirms that the queue has been identified. If the curve fit is not successful, the process 500 proceeds to block 518 and marks the human forms in the image as not forming queue.

In other embodiments, the process 500, at 520, draws a region of interest box around the bounding boxes (e.g., region of interest 410 in FIG. 5C) in the identified cluster. Accordingly, the region of interest box envelopes all of the bounding boxes in a cluster of bounding boxes. The process 500 generates an image of the area inside the region of interest and, at block 522, passes the image (e.g., as a JSON file) to a queue classification model, which may be a machine learning (ML) model, such as a trained neural network. The queue classification model is trained based on training data to determine whether provided images depict queues. For example, training data may be based on color images containing queues that are collected from a camera, collected from the internet, or collected from some other source. Each image is passed (e.g., as a JSON file) through a human form detection model configured to detect human forms in the image and generate bounding boxes around the identified human forms. The image is then edited such that all pixels falling outside the bounding boxes are given a value of zero and all pixels overlapping with the bounding boxes are given a value of one. Each raw image is then manually inspected for a queue. If a queue is present, the image is annotated by drawing a bounding box around the queue and the image is labeled as depicting a queue.

In some embodiments, synthetic images may also be generated. For example, a synthetic image may be created using a regular matrix filled with zeroes. Multi-colored boxes indicative of people in various configurations (e.g., stacking, scattering, s-curve, etc.) are overlaid and bounding boxes are colored in a particular order. In some embodiments, bounding boxes of various sizes may be created for more robust training.

During training, the image is cropped to isolate the bounding box around the queue and given a class label of “queue”. Regions of the image that include bounding boxes over human forms that are not in queues will also be cropped and given a class label of “not a queue”. A partially pre-trained classification model with additional transformer layers and a classification head is then trained based on the training data and utilized in the present approach. Accordingly, the queue classification model analyzes the image and outputs an indication of whether the image depicts a queue (block 524) or does not depict a queue (block 526).

In other embodiments, the process 500, at 528, as discussed above, generates a matrix in which all pixels in the image are represented by a one or a zero. All of the pixels are initially set to zero and then the pixels that overlap with the bounding boxes are set to one. At 530, the process 500 passes the matrix (e.g., as a JSON file) to a queue detection model, which may also be a ML model, such as a trained neural network. The queue detection model is trained based on training data to identify queues (block 532) in images and generate a region of interest box around the bounding boxes that form the identified queue. If the queue detection model does not detect a queue in the image, the queue detection model outputs an indication that now queue was detected (block 534). The queue detection model is an object detection model trained to detect an object class called “queue” based on training data that includes images of queues. For example, training data may be based on color images containing queues that are collected from a camera, collected from the internet, or collected from some other source, similar to those described above. Each image (e.g., as a JSON file) is similarly passed through a human form detection model configured to detect human forms in the image and generate bounding boxes around the identified human forms. The image is similarly edited such that all pixels falling outside the bounding boxes are given a value of zero and all pixels overlapping with the bounding boxes are given a value of one. Each raw image is then manually inspected for a queue. If a queue is present, the image is annotated by drawing a bounding box around the queue and the image is labeled as depicting a queue.

In some embodiments, as previously described, synthetic images may also be generated using a regular matrix filled with zeroes. Multi-colored boxes indicative of people in various configurations (e.g., stacking, scattering, s-curve, etc.) are overlaid and bounding boxes are colored in a particular order. In some embodiments, bounding boxes of various sizes may be created for more robust training.

The annotated images are used as full images to train the model. For example, a partially pre-trained model with additional transformers and a you only look once (YOLO) head is trained based on the training data images. Accordingly, the queue detection model is trained to receive images and output annotated images that identify queues in the images with a region of interest box around the identified queue.

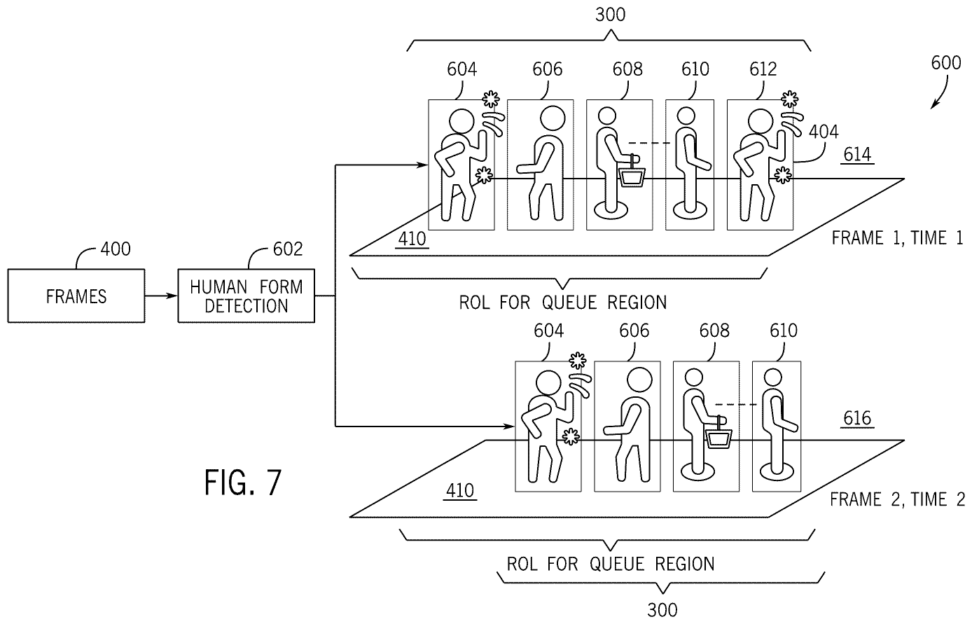

After a queue has been identified, the queue may be monitored by analyzing images of the queue taken at different times. FIG. 7 is a flow chart 600 illustrating human form detection in frames. Frames 400 depicting a queue 300 at different times (e.g., time 1 and time 2) are provided to a human form detection model 602, such as a trained neural network. The human form detection model 602 may identify a region of interest 410 in each frame 400, or annotated frames 400 may be provided to the human form detection model 602 with the region of interest 410 already identified. The human form detection model 602 identifies human forms within the region of interest 410 in a first frame 614 and a second frame 616 and creates bounding boxes 404, 604, 606, 608, 610, 612 around the identified human forms.

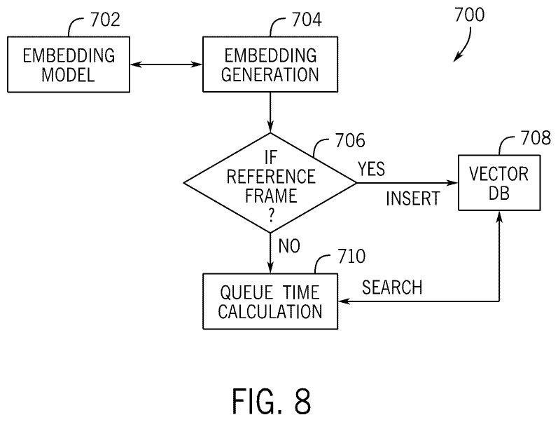

FIG. 8 is a flow chart of a process 700 for generating and comparing embeddings in monitoring a queue. An embeddings model 702, such as a trained neural network, generates embeddings (e.g., vector representations) at 704 for the human forms identified in the first frame (e.g., the reference frame, see decision 706) based on the bounding boxes 604, 606, 608, 610, 612 and adds the embeddings to an embeddings vector database 708.

As used herein, an embedding is a mathematical representation, such as a multi-dimensional vector and/or a hash value, of an object (e.g., text, image, etc.) that helps machine learning models, such as trained neural networks, understand relationships between objects. Each number in the vector represents a value along a dimension. The presently disclosed embeddings may have hundreds or even thousands of dimensions, such that it may not be practical for a human to manually generate and analyze the embeddings.

The process 700 may also generate unique object ids for one or more of the identified human forms (e.g., the last two human forms in the queue of FIG. 7, associated with bounding boxes 604 and 606). The embeddings model 702, such as a trained neural network, generates embeddings (block 704) for the identified human forms in the second frame (e.g., the target frame, see decision 706) and searches the embeddings vector database 708 for embeddings from the first frame that match. Matching embeddings indicate that the same human form appears in the first frame and the second frame.

If there are two or more matching human forms between the first frame and the second frame, at least two matching forms are assigned object ids and the displacement of each human form (e.g., in pixels) between the first frame and the second frame is divided by the time elapsed between the time stamps of the two frames to determine a speed at which the queue is moving (block 710). In embodiments in which the queue is a queue of non-human objects, the speed at which the queue is moving may represent a rate at which cars in a queue are moving, a rate at which boxes on a conveyor belt move, and so forth. Performing this calculation for two or more human forms and taking an average results in a more accurate value that is less affected by noise associated with human forms being spaced differently, and so forth. A new frame may be captured at a subsequent time (e.g., time 3) and the process repeated for the new frame, with the frame taken at time 2 shifting to the role of the reference frame.

If there is only one matching human form between the first and second frames, the process 700 may assign an object id to the matching human form and identify another human form adjacent to the matching human form in the second frame, generate embeddings (block 704) for the adjacent human form, and wait for a subsequent frame to see if the matching human form and the adjacent human form appear in the subsequent frame. If so, the human form detection model 602 (e.g., a trained neural network) calculates a queue movement rate (block 710) based on an average of the human form displacement divided by the elapsed time, as described above.

If there are more than two embeddings in a matching group, that implies that a human form appears more than once in at least one of the frames and the human form detection model 602 of FIG. 7 is experiencing an error. In such cases, the process 700 discards the second frame and begins the process again when a subsequent (e.g., third) frame is received. If there are no matches between the first and second frame, indicating that there are no human forms that appear in both the first frame and the second frame, the process 700 discards the second frame and begins the process 700 again when a subsequent (e.g., third) frame is received.

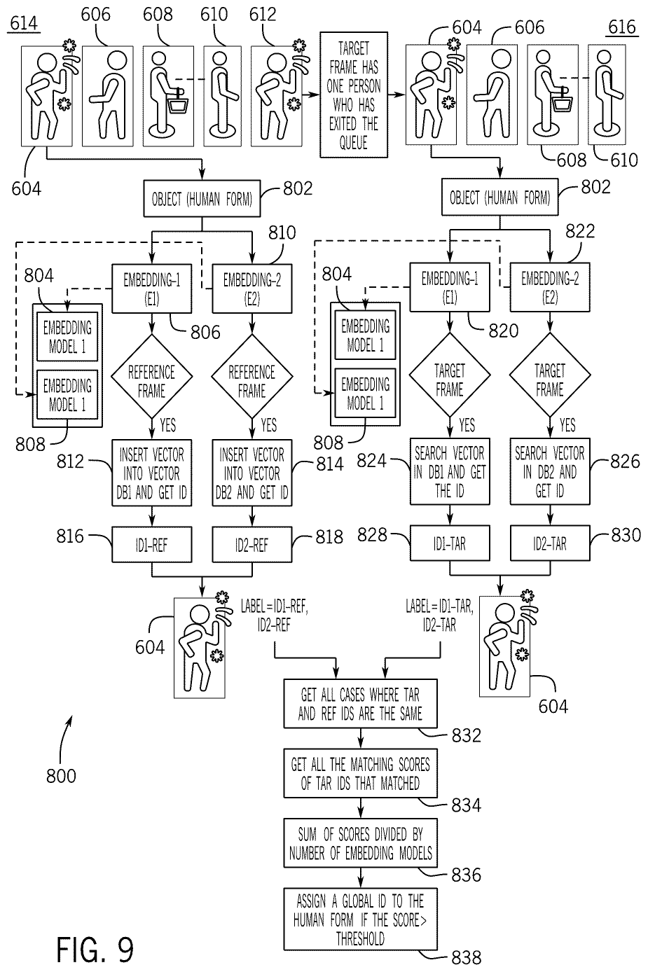

In some embodiments, multiple embedding models 702 (e.g., trained neural networks) may be used to generate embeddings for a human form, which may be compared to validate the human form. Accordingly, FIG. 9 is a flow chart of a process 800 for identifying human forms in different frames using multiple embedding models. As shown, a human form (e.g., associated with bounding box 604) is recognized in the first frame 614 and an object 802 is generated. A first embedding model 804 is used to generate a first embedding 806 for the human form appearing in the first frame 614 and a second embedding model 808 is used to generate a second embedding 810 for the human form appearing in the first frame 614. If the first frame 614 is not a reference frame, at 812 and 816, respectively, the first and second embeddings are added to respective vector databases and given respective ids 814, 818.

Similarly, the human form (e.g., associated with bounding box 604) is recognized in the second frame 616 and an object 802 is generated. The first embedding model 804 is used to generate a first embedding 820 for the human form appearing in the second frame 616 and the second embedding model 808 is used to generate a second embedding 822 for the human form appearing in the second frame 616. If the second frame 616 is not a reference frame, at 824 and 826, respectively, the first and second embeddings are added to respective vector databases and given respective ids 828, 830.

At 832, the process identifies and retrieves all instances in which the ids 816, 818 for the first frame 614 and the ids 828, 830 for the second frame 616 match. At 834, the process 800 retrieves matching scores for the matching ids 828, 830 for the second frame. The matching scores may include, for example, an algorithmically calculated degree of similarity that is reflected as a score on a set scale (e.g., 0-1, 0-10, 0-100, etc.). At 836, the process 800 calculates a sum of the retrieved matching scores and divides the sum by the number of embedding models used. If the average score calculated at 836 is greater than or equal to a threshold value, the process 800 at 838 assigns a global id to the human form (e.g., associated with bounding box 604). As previously described, after the human form has been identified in the first frame 614 and the second frame 616, a pixel distance between the positions of the human form in the first frame 614 and the second frame 616 may be calculated, and an elapsed time between the first frame 614 and the second frame 616 may be used to determine a rate at which the queue is moving. In other embodiments, distance may be calculated using one or more fiducial markers (e.g., objects in the frame of a known size, in a known location, and/or multiple objects spaced apart by known spacing, that provide a point of reference and/or scale for determining the size of objects in the frame and the distance between objects. In other embodiments, images from a camera in a fixed known location with a fixed view and/or image size such that the distance in the images is known and/or can be correlated to a real-world distance.

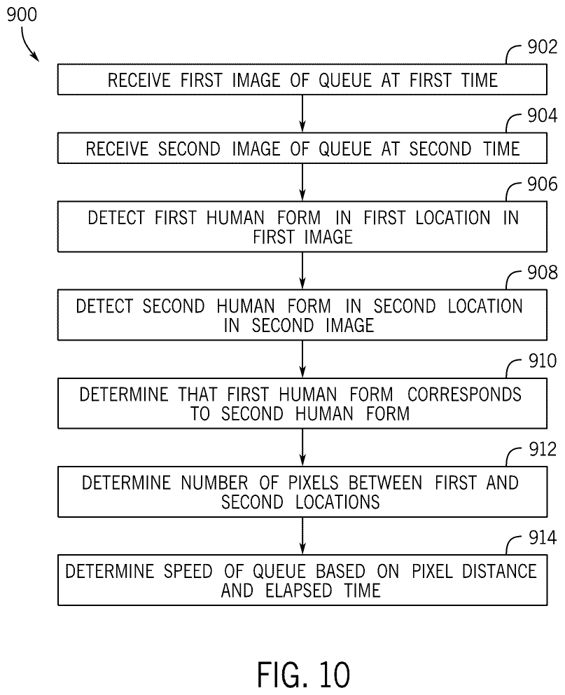

FIG. 10 is a flow chart of a process 900 for monitoring a queue. At 902, the process 900 receives a first image (e.g., frame) of a queue at a first time. At 904, the process 900 receives a second image (e.g., frame) of the queue at a second time. The first and second images may be still images, frames of a video, etc. The first and second images may have been captured from the same camera or from different cameras disposed at different locations (e.g., such that the first and second images are different perspectives of the same queue).

At 906, the process 900 detects one or more human forms at first locations in the first image. At 908, the process 900 detects one or more human forms in second locations in the second image. As previously described, the process 900 may utilize computer vision, a human form detection model, an object detection model, an object classification model, etc.

At 910, the process 900 determines that the first human form in the first image corresponds to the second human form in the second image. As previously described, this may include generated embeddings for identified human forms and comparing embeddings to identify one or more human forms that appear in both the first image and the second image.

Typically, queue monitoring has been manually performed by humans. In practice, a human may observe a queue in person or via images. The human may monitor the queue by observing how long the queue is, or by observing how quickly a particular person moves through the queue. The human may identify a person to monitor by characteristics of their body (e.g., short, tall, hair color, gender, facial hair, etc.), their clothing (e.g., colors, type of clothing, etc.), or other characteristics (e.g., carrying a backpack, has a suitcase, etc.). As performed manually by a human, this process is subjective, varies from human to human, is not consistent or repeatable, is subject to human error, and is limited to only tracking one or two people at a time. In sharp contrast, the disclosed techniques use a computer to identify human forms in images and generate embeddings for human forms, which is objective, repeatable, and scalable, enabling a computer to identify and monitor large numbers of human forms across many queues. Accordingly, not only are the disclosed techniques different from the way a human would manually perform these tasks, but they are more accurate and are performed with fewer errors than when done manually by a human.

At 912, the process 900 calculates a number of pixels between the first and second locations. For example, the process 900 may determine how many pixels a human form that appears in the first image and the second image moved between the first image and the second image. At 914, the process 900 calculates the speed of the queue based on the pixel distance calculated at 912 and the elapsed time between the timestamp of the first image and the timestamp of the second image. For example, the process 900 may divide the pixel distance calculated at 912 by the time elapsed between the timestamp of the first image and timestamp of the second image to determine a speed at which the queue is moving. In some embodiments, if multiple human forms are identified in the first and second images, the queue speed may be calculated for each human form and then averaged over the number of identified human forms in the queue to determine the average queue speed. A human manually performing queue monitoring may estimate how far a particular person has moved in a queue over an estimated period of time. Accordingly, the disclosed techniques, as performed by a computer, by using pixel distances and time stamps to determine how quickly a human form is moving through a queue, especially when averaged over multiple human forms, results in more accurate queue speed data.

The presently disclosed techniques are directed to autonomously identifying and monitoring queues of people. Frames (e.g., still images, or frames from a video) of one or more queues may be captured by one or more cameras. Computer vision techniques paired with a machine learning model may be used to detect human forms in the frames. Each human form in the frame may then be converted into bounding boxes such that each individual in the frame is anonymized (by removing any identifying characteristics). The queue may be identified based on an analysis of the bounding boxes in the frame. In particular, the characteristics of the bounding boxes in the frame (e.g., the size, shape, arrangement, number of bounding boxes) may be used to identify that a queue has formed. In some embodiments, each bounding box in the frame may be converted into one or more vectors based on coordinates of the respective corners of the bounding box. The resulting vectors may be run through a clustering algorithm to identify queues. Here, large clusters of vectors (e.g., greater than some threshold value) may be identified as queues and small clusters (e.g., corresponding to groups of one or two people that appear in frames) may be ignored. In another embodiment, a line passing through respective coordinates of the bounding boxes may be provided to a curve fitting algorithm. In these embodiments, lines having certain characteristics may be identified as queues. In further embodiments, a neural network trained on a training data set of human-annotated frames may be configured to receive the frames or characteristics of the bounding boxes and identify queues.

Once a queue has been identified, the queue can be monitored by analyzing movement of people in the queue between a target frame and a reference frame. For example, one or more human forms may be detected in the reference frame and respective embeddings created for each detected human form. In some embodiments, multiple algorithms or models may be used to generate respective embeddings for the detected human form. Hashes identifying the human forms may be generated based on the embeddings and stored in a database. Similarly, one or more human forms may be detected in the target frame and respective embeddings created for each human form. As with the reference frame, multiple algorithms or models may be used to generate respective embeddings for the human forms. The database is searched for hashes generated for the reference frame and the target frame that match, indicating that a corresponding human form appears in both the reference frame and the target frame. If there are no matches between the reference frame and the target frame, the process is repeated with the target frame as the reference frame and a subsequent frame (e.g., a new frame) as the target frame. The location of the detected human form in the reference frame and the target frame may be compared to determine a number of pixels the human form moved between the reference frame and the target frame. Further, the timestamps of the reference frame and the target frame may be compared to determine an elapsed time between the reference frame and the target frame. Based on the number of pixels moved and the elapsed time for one or more human forms in the queue, the speed of the queue may be determined.

Technical effects of the disclosed techniques include enabling computers to identify human forms in images of queues, identify queues, and calculate how quickly queues are moving, which has traditionally been performed manually by humans. Accordingly, use of the disclosed techniques results in more accurate and objective data for driving determinations regarding when to open and close registers and/or processing stations, assessing performance of cashiers or other operators, and evaluating processes. Accordingly, use of the disclosed techniques may provide more objective, standardized, and scalable monitoring of queues, as well as reduced time in the queue for customers and improved customer experiences.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
receiving a first image comprising a view of a queue at a first time;
receiving a second image comprising the view of the queue at a second time, subsequent to the first time;
detecting a first human form at a first location in the first image;
detecting a second human form at a second location in the second image;
determining, based on respective characteristics of the first human form and the second human form, that the first human form corresponds to the second human form;
determining a number of pixels between the first location and the second location; and
determining a speed of the queue based on the number of pixels between the first location and the second location and an amount of time elapsed between the first time and the second time.

2. The method of claim 1, wherein detecting the first human form at the first location in the first image comprises:
detecting, via computer vision, using the first image, a plurality of human forms in the queue;
for each of the plurality of human forms in the queue:
generating a respective bounding box for the respective human form; and
generating, based on the respective bounding box for the respective human form, a respective embedding comprising the respective characteristics of the respective human form; and
identifying a first embedding from the plurality of embeddings that corresponds to the first human form in the first image.

3. The method of claim 2, wherein the bounding boxes are generated on a first device and wherein the embeddings are generates on a second device.

4. The method of claim 2, wherein detecting the first human form at the second location in the second image comprises:
detecting, via the computer vision, using the second image, the plurality of human forms in the queue; and
for each of the plurality of human forms in the queue:
generating an additional respective bounding box for the respective human form; and
generating, based on the additional respective bounding box for the respective human form, an additional respective embedding comprising the respective characteristics of the respective human form; and
identifying a second embedding from the plurality of additional embeddings that corresponds to the first human form in the second image.

5. The method of claim 4, wherein determining, based on the respective characteristics of the first human form and the second human form, that the first human form corresponds to the second human form comprises:
comparing the first embedding to the second embedding; and
in response to the first embedding matching the second embedding, determining that the first human form appears in the first image and the second image.

6. The method of claim 5, wherein the first and second embeddings are generated via a first algorithm, and wherein determining, based on the respective characteristics of the first human form and the second human form, that the first human form corresponds to the second human form further comprises:
generating, via a second algorithm, a third embedding comprising characteristics of the first human form based on the respective bounding box for the first human form;
generating, via the second algorithm, a fourth embedding comprising the characteristics of the first human form based on the respective additional bounding box for the first human form;
comparing the third embedding to the fourth embedding; and
in response to the third embedding matching the fourth embedding, determining that the first human form has been identified in the first image and the second image.

7. The method of claim 2, further comprising identifying the queue by:
generating, for each of the respective bounding boxes, a respective vector;
generating, using a clustering algorithm on the respective vectors, a cluster score; and
identifying, based on the cluster score exceeding a threshold value, the queue.

8. The method of claim 2, further comprising identifying the queue by:
generating, for each of the respective bounding boxes, a set of coordinate pairs corresponding to corners of the respective bounding box;
providing the sets of coordinates for the respective bounding boxes to a curve fitting algorithm; and
receiving, from the curve fitting algorithm, an indication that a curve passing through the sets of coordinates satisfies pre-defined conditions for the queue.

9. The method of claim 2, further comprising identifying the queue by:
providing the second image or the respective bounding boxes to a trained neural network, wherein the trained neural network is configured to identify the queue in the second image or based on the respective bounding boxes; and
receiving, from the trained neural network, an indication the trained neural network identified the queue in the second image or based on the respective bounding boxes.

10. The method of claim 2, comprising:
identifying a third human form of the plurality of human forms at a third location in the first image;
identifying a fourth human form of the plurality of human forms at a fourth location in the second image;
determining, based on respective characteristics of the third human form and the fourth human form, that the third human form corresponds to the fourth human form; and
determining an additional number of pixels between the third location and the fourth location, wherein the speed of the queue is further determined based on the additional number of pixels between the third location and the fourth location and the amount of time elapsed between the first time and the second time.

11. The method of claim 1, wherein the first image is from a first camera and the second image is from a second camera, wherein determining the number of pixels between the first location and the second location is based on respective positions and orientations of the first camera and the second camera.

12. A system, comprising:
processing circuitry; and
a memory, accessible by the processing circuitry, and storing instructions that, when executed by the processing circuitry, cause the processing circuitry to execute a client instance, wherein the client instance is configured to perform operations comprising:
receiving a first image comprising a view of a queue at a first time;
receiving a second image comprising the view of the queue at a second time, subsequent to the first time;
detecting a first human form at a first location in the first image;
detecting a second human form at a second location in the second image;
determining, based on respective characteristics of the first human form and the second human form, that the first human form corresponds to the second human form;
determining a number of pixels between the first location and the second location; and
determining a speed of the queue based on the number of pixels between the first location and the second location and an amount of time elapsed between the first time and the second time.

13. The system of claim 12, wherein detecting the first human form at the first location in the first image comprises:
detecting, via computer vision, using the first image, a plurality of human forms in the queue;
for each of the plurality of human forms in the queue:
generating a respective bounding box for the respective human form; and
generating, based on the respective bounding box for the respective human form, a respective embedding comprising the respective characteristics of the respective human form; and
identifying a first embedding from the plurality of embeddings that corresponds to the first human form in the first image.

14. The system of claim 13, wherein detecting the first human form at the second location in the second image comprises:
detecting, via the computer vision, using the second image, the plurality of human forms in the queue; and
for each of the plurality of human forms in the queue:
generating an additional respective bounding box for the respective human form; and
generating, based on the additional respective bounding box for the respective human form, an additional respective embedding comprising the respective characteristics of the respective human form; and
identifying a second embedding from the plurality of additional embeddings that corresponds to the first human form in the second image.

15. The system of claim 14, wherein the first and second embeddings are generated via a first algorithm, and wherein the operations comprise:
generating, via a second algorithm, a third embedding comprising characteristics of the first human form based on the respective bounding box for the first human form;
generating, via the second algorithm, a fourth embedding comprising characteristics of the first human form based on the respective additional bounding box for the first human form;
comparing the third embedding to the fourth embedding; and
in response to the third embedding matching the fourth embedding, determining that the first human form has been identified in the first image and the second image.

16. The system of claim 12, wherein the first image is from a first camera and the second image is from a second camera, wherein determining the number of pixels between the first location and the second location is based on respective positions and orientations of the first camera and the second camera.

17. A non-transitory, computer readable medium comprising instructions that, when executed by processing circuitry, cause the processing circuitry to perform operations comprising:
receiving a first image comprising a view of a queue at a first time;
receiving a second image comprising the view of the queue at a second time, subsequent to the first time;
detecting a first object at a first location in the first image;
detecting a second object at a second location in the second image;
determining, based on respective characteristics of the first object and the second object, that the first object corresponds to the second object;
determining a number of pixels between the first location and the second location; and
determining a speed of the queue based on the number of pixels between the first location and the second location and an amount of time elapsed between the first time and the second time.

18. The non-transitory, computer readable medium of claim 17, wherein detecting the first object at the first location in the first image comprises:
detecting, via computer vision, using the first image, a plurality of objects in the queue;
for each of the plurality of objects in the queue:
generating a respective set of bounding boxes for the respective object, wherein the respective set of bounding boxes comprises a plurality of nested bounding boxes, wherein each bounding box of the plurality of bounding boxes in the set of bounding boxes is of a different color; and
generating, based on the respective set of bounding boxes for the respective object, a respective embedding comprising the respective characteristics of the respective object; and
identifying a first embedding from the plurality of embeddings that corresponds to the first object in the first image.

19. The non-transitory, computer readable medium of claim 18, wherein the operations further comprise training a machine learning model based on the sets of bounding boxes.

20. The non-transitory, computer readable medium of claim 18, wherein the operations further comprise identifying the queue, comprising:
providing the second image or the respective bounding boxes to a trained neural network, wherein the trained neural network is configured to identify the queue in the second image or based on the respective bounding boxes; and
receiving, from the trained neural network, an indication the trained neural network identified the queue in the second image or based on the respective bounding boxes.
